(19) United States
(12) Patent Application Publication
(10) Pub. No.: US 2009/0254898 A1
(43) Pub. Date: Oct. 8, 2009

(54) CONVERTING A DEVICE FROM ONE SYSTEM TO ANOTHER

(75) Inventors: Bhrighu Sareen, Redmond, WA (US); Dilesh Dhokia, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,158

(22) Filed: Apr. 8, 2008

(51) Int. Cl. G06F 9/445; G06F 15/177; G06F 11/14

(52) U.S. Cl. 717/174; 713/1; 713/2; 714/6; 714/E11.113

(57) ABSTRACT

Re-purposing a computer from one operating system to another is both simplified and made less susceptible to error by moving original system firmware to a backup location and then installing both new firmware and the new operating system in one process. Because the original firmware is maintained and accessible, should the new firmware, for example, a BIOS, fail, the original firmware can be restored and the process restarted. To assist in the seamless change from one operating system to another, an inventory of computer assets may be used to built an installation program and removable memory for use in the upgrade.

### BACKGROUND

In a managed environment, for example, a corporate network, updating systems to a new version of an operating system or new version of an application is often accomplished by creating and copying an “image” of all the data on in a system disk. The image may be used to re-write all the data on a system disk of the target machine. Special remote management software may be used to support the replacement process, although, in many cases, the physical disk drive of the target system may be removed and installed in a host system to accomplish the upgrade. After the system disk is rewritten, it may be re-installed in the target system and rebooting using the newly installed software.

However, to re-purpose a computer, e.g. change from one operating system to another, more may be required than just changing operating system software on a hard disk. Often, new firmware corresponding to a new operating system may be required for components with their own programming stored in separate non-volatile memories. For example, a basic input/output system (BIOS) and boot loader may be stored in a BIOS chip or option ROM may require changes or replacement. In addition, peripheral components such as an input/output (I/O) interface or removable disk player/burner may also require updates to perform optimally, or at all, with a new operating system. Orchestrating these steps even for an experienced computer management team can be a challenge. To further complicate matters, special software tools may be required to re-write firmware for some components, e.g. a DVD burner. These tools may only be required long enough to perform the update and are likely to be specific to a particular device manufacturer. For a professional the process is tedious. For an individual without special training, the process may be a roll of the dice, with the result of a misstep being a non-operational mix of old and new firmware and software.

### SUMMARY

A process for reliably re-purposing a computer involves taking an inventory of a computer and preparing a custom installation program for coordinating both firmware and software installation. The installation program incorporates special firmware installation tools, if required, and performs all the steps required to both update firmware as required and install new software, such as an operating system. The installation program may also include test utilities to confirm successful progress through stages of the installation process. The installation program and all related components, e.g. firmware, software, and installation tools may be written to a removable memory, such as a universal serial bus removable drive.

The removable memory may also include a boot program. The target computer may boot from the removable drive to provide a known environment supporting the remainder of the installation process. To provide the ability to recover from errors, a backup of current firmware is made prior to overwriting it with new firmware. If an error occurs, operation can be directed to the backup copy to allow restoration of the system.

### BRIEF DESCRIPTION OF THE DRAWINGS

FIG. 1 is a block diagram of an electronic device in the form of a computer suitable for converting from one system to another;

FIG. 2 is a method of preparing a memory for use in converting a device from one system to another; and

FIG. 3 is a block diagram of memory showing various data and executable programs.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

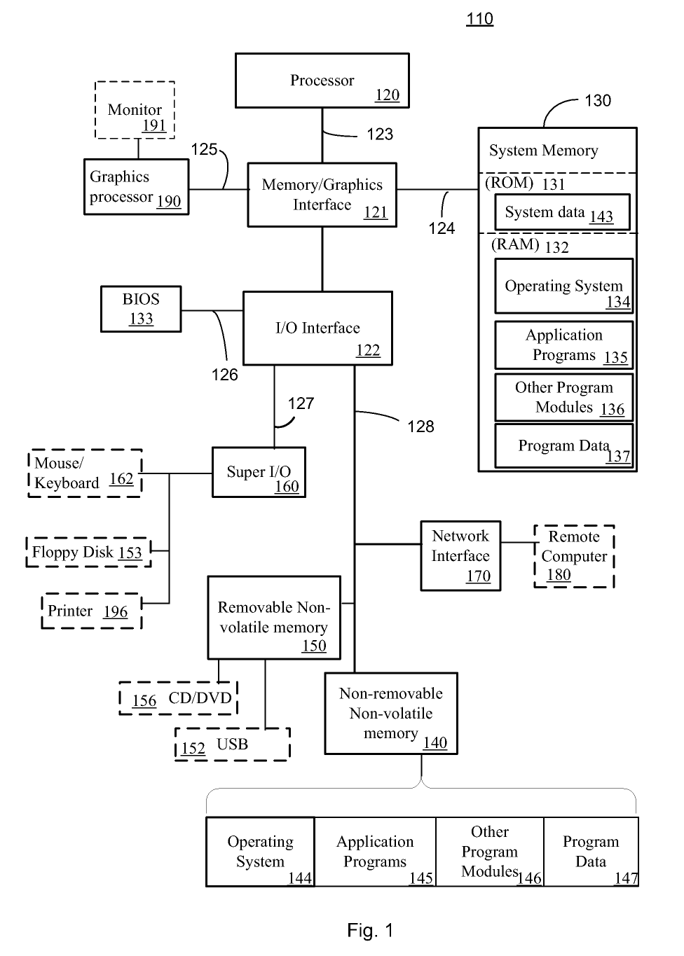

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up. The BIOS memory 133 may be separate from other memory and is typically non-volatile. Along with the BIOS, a boot loader may be present in the BIOS memory 133, or an associated option memory, that also supports the initial boot process.

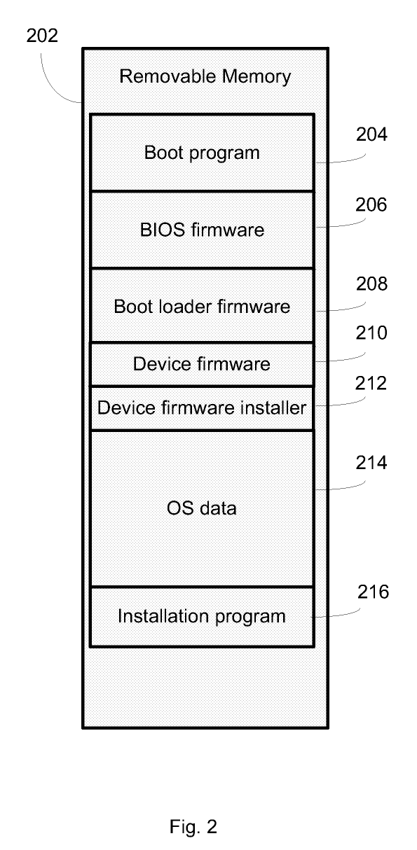

In some embodiments, a security module 129 may be incorporated to manage metering, billing, and enforcement of policies, such as ensuring certain programs are running. The security module 129 is discussed more below, especially with respect to FIG. 2. In various embodiments the security module 129 is coupled to the I/O interface 122 via the SPI bus 126, the system bus 123, or both. In some cases, where the processor architecture allows, a connection 181 between the security module 129 and the processor 120 may allow the security module 129 to use a hardware debug/test access port (not depicted) on the processor. Hardware debug ports exist in various brands of processors and allow direct read out of internal registers in the processor. In Intel processors, the hardware debug port is called a test access port (TAP) and in AMD processors, it is called a Hardware Debug Tool (HDT) debug port. The use of such ports by the security module 129 is discussed below.

A super input/output chip 160 may be used to connect to a number of ‘legacy’ peripherals, such as floppy disk 153, keyboard/mouse 162, and printer 196, as examples. The super I/O chip 160 may be connected to the I/O interface 121 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The USB memory 152 may contain an installation program and supporting firmware and software used in a re-purposing process described below.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

FIG. 2 depicts a memory 202, particularly a removable memory, showing memory contents suitable to support converting a device from one system to another. A boot program 204 may be used to support booting the target device. For example, during the initial boot phase, the boot program 204 in memory 202 may be selected as the boot source. Booting from the memory 202 may provide a stable, known environment for the process of re-purposing the computer. Additionally, using resources from the memory 202 helps to ensure that no computer resources are in use or locked when their associated memory locations are being updated, whether firmware or software.

BIOS firmware 206 may be used to update BIOS memory 133. Prior to overwriting an existing BIOS, such as the one in memory 133 of FIG. 1, the existing BIOS may be copied to a known location. For example, the copy may be made in the BIOS memory 133 itself, or may be copied to an unused area of memory 202. Should an error occur during the installation of the new BIOS, an embedded controller (EC) may redirect boot activity to the original BIOS in the backup location.

Similar to the BIOS firmware 206, a boot loader firmware 208 may be stored on the memory 202 and used to update a corresponding existing boot loader on the computer. The existing boot loader may be copied as well, for use in case a subsequent error requires reverting to the original configuration.

Device firmware 210 may be stored on the memory 202. The device firmware 210 may be for a number of embedded devices or peripherals, such as a disk controller or optical disk burner. Because some devices have unique update procedures, a device firmware installer 212 may also be loaded on the memory 202 and executed during the conversion process. For example, a manufacturer-specific version of the device firmware installer 212 may poke certain memory locations in the device register stack as part of the update process. An installation program 216 may call the device firmware installer 212 and pass it parameters related to the device address and the address of the device firmware 210 as part of the conversion process.

Operating system data 214 may include a full copy of an operating system to be used after completion of the conversion. For example, the conversion may be from a Linux environment to a Windows™ environment.

The installation program 216 may be executed after booting to manage the process of confirming the current configuration, backing up the current firmware, overwriting the current firmware, and installing the new operating system. The installation program may also incorporate configuration settings, such as Internet connections, language, etc., for configuring the computer after booting into the new operating system.

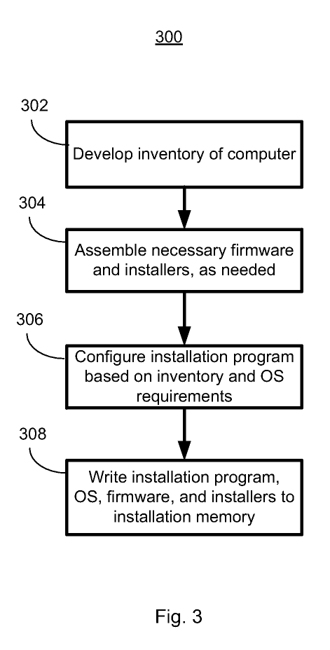

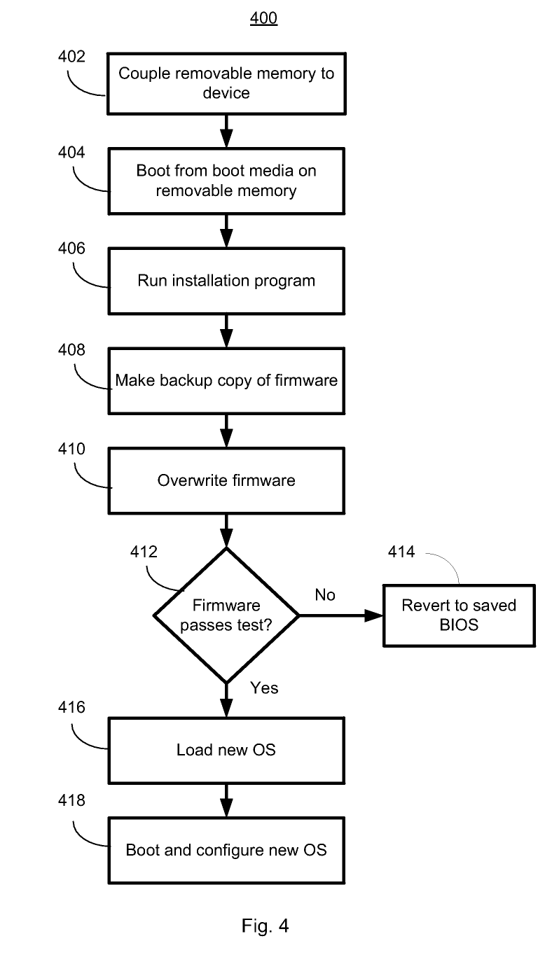

FIG. 3 illustrates a method 300 of preparing a memory for use in converting a device, such as a computer, from one system to another. The memory may be similar to the memory described with respect to FIG. 2. At block 302, an inventory of the computer assets may be taken. For example, an inventory tool may be downloaded onto the computer to determine what operating system (OS) is currently installed, what manufacturer and version BIOS is running, and the type and version level of firmware for any peripherals or support circuits.

At block 304, the results of the inventory may be used to assemble correct types and versions of OS, firmware, and firmware installers that may be required during the conversion process.

At block 306, an installation program may be generated or configured using the inventory of computer assets that encompasses the installation process for both the required new elements for the computer as well as any special installation programs or system requirements. For example, firmware for a particular BIOS may be installable by the installation program, whereas changing the firmware in an optical disk drive may require use of a custom installer. In the first instance, the installation program may be configured to directly install the new BIOS. In the second instance, the installation program may have to call the custom installer and pass it relevant parameters.

At block 308, after the required components have been assembled and the installation program generated or configured, each of these elements may be loaded onto the memory and appropriately marked and packaged, as needed. For example, an installation program, an operating system, and any required firmware may be stored on the memory. In one embodiment, the firmware may include a new BIOS for use in overwriting a target, existing, BIOS with the new BIOS.

FIG. 4 illustrates a method 400 of performing a conversion of computer from one operating system to another. At block 402, a memory, such as a the removable memory 202 described above with respect to FIG. 2 and FIG. 3, may be coupled to the computer. In one embodiment, the coupling may be physical, for example, via a USB port. In other embodiments, a logical connection may be sufficient, as long as the connection can persist or be recovered after a boot cycle.

At block 404, the computer may boot from the memory 202. This is not a requirement, but may simplify the conversion process for reasons discussed above.

At block 406, an installation program, such as installation program 216 may be executed. As described above, the installation program may be capable of orchestrating each aspect of the conversion process, from firmware upgrade and testing, to installation and configuration of a new operating system.

At block 408, the installation program may make a backup copy of each firmware element to be upgraded. If more than one firmware is involved, each may converted and tested together, each may be handled sequentially, or a combination of both may be performed. For example, a BIOS may be installed and tested first. After the BIOS is successfully installed, firmware for one or more peripherals may be upgraded in a batch, as requirements allow. The backup process may be to a fixed location and may the backup may be made to system non-volatile memory, such as hard disk drive 140, free space at the location being upgraded, or on the memory 202. Other firmware that may be backed up prior to overwriting may include a boot loader, an optical media controller, a disk manager, or a memory controller.

At block 410, the target firmware, e.g. a BIOS, may be overwritten with a new BIOS from the memory 202. If no obvious errors occur during the write process, execution may continue at block 412.

At block 412, testing of the new firmware may occur to ensure the new firmware meets certain criteria, for example, that a hash matches a known hash, or simply that the firmware operates as expected. Perhaps the simplest test is reboot the computer and see if it performs correctly. This can be a risky step when no recovery steps are in place. An incorrect, incompatible, or incorrectly installed BIOS can turn a computer into a brick, that is, render it completely non-functional. However, rebooting a computer in accordance with this disclosure take advantage of an embedded controller, or EC, that starts the BIOS in most conventional computers.

After the EC starts the BIOS, errors can still be reported back to the EC. Should an error occur, the ‘no’ branch from block 412 may be taken to block 414. The EC may then redirect execution to the backup BIOS, allowing both booting from a known good BIOS and subsequent investigation to determine the cause of the error.

If the firmware passes the test and no errors are reported, the ‘yes’ branch from block 412 may be taken to block 416. At block 416, installation of software components, such as the new operating system and applications may be installed. Installation of these components is usually less at risk from errors because execution of the BIOS has been secured.

At block 418, the computer may be rebooted into the new operating system, and configuration for system characteristics like network connection, time zones, application configuration, etc. may take place.

The ability for this process to essentially make converting a computer from one operating system to another operating system as simple as plugging in a removable memory and turning on the power is a significant improvement over the tedious and risky process of piecemeal upgrades to firmware and operating system that can leave a computer in an unknown and non-functional state.

The ability for the process to recover from any point in the conversion process to a minimum level of known functionality provides an advantage to not only professional information technology personnel, but especially to the amateur of unknown skill and training who simply wants to re-purpose his or her computer and move on.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of re-purposing a computer using a removable memory comprising:
installing an installation program, an operating system, and a firmware on the removable memory;
coupling the removable memory to the computer;
executing the installation program;
copying, under control of the installation program, a target firmware on the computer to a backup location;
overwriting the target firmware with a new firmware;
executing the new firmware;
raising an error if operation of the new firmware fails;
redirecting execution to the target firmware at the backup location responsive to raising the error; and
installing the operating system if operation of the new firmware succeeds.

2. The method of claim 1, wherein copying a target firmware to the backup location comprises:
copying a boot loader program to the backup location; and
copying a basic input/output system (BIOS) to the backup location.

3. The method of claim 1, wherein the firmware is a new BIOS, and overwriting the target firmware with new firmware comprises overwriting a target BIOS with the new BIOS.

4. The method of claim 1, further comprising taking an inventory of computer assets for use when installing the installation program, the operating system, and the firmware on the removable memory.

5. The method of claim 4, further comprising generating the installation program using the inventory of computer assets.

6. The method of claim 5, further comprising selecting the firmware to install on the removable memory using the inventory of computer assets.

7. The method of claim 1, further comprising booting from the removable memory prior to executing the installation program.

8. The method of claim 7, further comprising:
booting from the new operating system.

9. The method of claim 8, further comprising:
automatically configuring local operating characteristics following booting from the new operating system.

10. A removable computer-readable storage medium comprising:
a port for coupling to a computer;
computer-executable instructions for booting a computer using a first operating system;
computer-executable instructions for making a copy of a current BIOS of a computer in a known location;
computer-executable instructions for writing a new BIOS over the current BIOS of the computer;
computer-executable instructions for installing a new operating system from the removable computer-readable storage medium to the computer when the new BIOS meets an installation criteria; and
computer-executable instructions for reverting to the copy of the current BIOS when the new BIOS fails to meet the installation criteria.

11. The removable computer-readable storage medium of claim 10, further comprising:
computer-executable instructions for taking an asset inventory of the computer;
computer-executable instructions for downloading appropriate firmware corresponding to the asset inventory; and
computer-executable instructions for generating an installation program based on the asset inventory.

12. The removable computer-readable storage medium of claim 10, further comprising:
computer-executable instructions for making a copy of a current boot loader of the computer;
computer-executable instructions for writing a new boot loader over the current boot loader of the computer; and
reverting to the copy of the current boot loader when the new boot loader fails to meet a boot loader installation criteria.

13. A method of changing a computer executable operating environment comprising:
installing an installation program, a new operating system, and one or more new firmware components on a removable memory;
coupling the removable memory to the computer;
booting the computer from a boot module on the removable memory;
executing the installation program;
copying, under control of the installation program, an existing one or more firmware components on the computer to a backup location, each of the existing one or more firmware components corresponding to the one or more new firmware components;
overwriting each of the existing one or more firmware components with the corresponding one or more new firmware components;
performing a test of the one or more new firmware components;
raising an error if the test fails;
restoring the copy of the existing one or more firmware components on the computer from the backup location.

14. The method of claim 13, wherein performing a test of the one or more new firmware components comprises:
executing each of the new firmware components; and
determining whether the each of the new firmware components performs as expected.

15. The method of claim 13, wherein the computer executable operating environment comprises, a BIOS firmware, a boot loader firmware, a peripheral firmware, and an operating system.

16. The method of claim 13, wherein installing and installation program and one or more new firmware components on the removable memory further comprises installing a new operating system on the removable memory, and the method further comprising:
installing the new operating system on the computer when the test passes.
